(19) United States
(12) Patent Application Publication
(10) Pub. No.: US 2004/0191921 A1
(43) Pub. Date: Sep. 30, 2004

(54) Simultaneous chemical separation and surface-enhanced raman spectral detection

(76) Inventors: Stuart Farquharson, Meriden, CT (US); Paul Maksymiuk, South Windsor, CT (US)

Correspondence Address: IRA S. DORMAN, Suite 200, 330 Roberts Street, East Hartford, CT, 06108, US

(21) Appl. No.: 10/818,202

(22) Filed: Apr. 5, 2004

Related U.S. Application Data
(63) Continuation-in-part of application No. 10/372,621, filed on Feb. 21, 2003.

(51) Int. Cl. G01N 21/00

(52) U.S. Cl. 436/172

(57) ABSTRACT

A stationary medium is employed both to separate chemicals from a sample solution and also for surface-enhanced Raman spectral analysis of the separated chemical, thereby greatly reducing the complexity of the apparatus and enhancing the efficiency of the chemical analysis method.

### CROSS-REFERENCE TO RELATED APPLICATION

This application is a continuation-in-part of copending U.S. patent application Ser. No. 10/372,621, filed Feb. 21, 2003.

### BACKGROUND OF THE INVENTION

The combination of chemical separation and analysis has long been recognized as invaluable to the analytical chemist in identifying chemicals at extremely low concentrations in complex matrices. For example, a drug and its metabolites can be effectively separated from blood plasma, using gas chromatography, and thereafter identified by the chemical fragments detected by mass spectrometry (see J. Chamberlain, The Analysis of Drugs in Biological Fluids, CRC Press, Boca Raton, 995, 2nd ed. chap. 6 and 7).

More recently, the combination of liquid chromatography, or flow injection analysis, with surface-enhanced Raman spectroscopy (SERS) has been investigated for such applications (see J-M. L. Sequaris and E. Koglin, Anal. Chem., 59,525 (1987); R. D. Freeman, R. M. Hanmaker, C. E. Meloan, and W. G. Fateley, Appl. Spectrosc., 42,456-460 (1988); F. Ni, R. Sheng and T. M. Cotton, Anal. Chem., 62, 1958(1990); G. T. Taylor, S. K. Shanna and K. Mohanan, Appl. Spectrosc., 44,635 (1990); R. Sheng, F. Ni and T. M. Cotton, Anal. Chem., 63,437 (1991); N. J. Pothier and R. K. Force. Appl. Spectrosc., 46, 147 (1992); L. M. Cabalin, A. Ruperez and J. J. Laserna, Talanta, 40, 1741 (1993); K. T. Carron and B. J. Kennedy, Anal. Chem., 67. 3353 (1995); L. M. Cabalin, A. Ruperez and J. J.

Laserna, Anal. Chim. Acta, 318, 203(1996); N. J. Szabo and I. D. Winefordner, Appl. Spectrosc., 51.965 (1997); B. J. Kennedy, R. Milofsky and K. T. Carron, Anal. Chem., 69, 4708 (1997); and W. F. Nirode, G. L. Devault, M. J. Sepaniak and R. O. Cole, Anal. Chem., 72, 1866(2000)). Advantages of this combination of techniques include minimal sample preparation requirements, unrestricted use of water in the mobile phase, high chemical specificity through abundant molecular vibrational information, and extreme sensitivity, as demonstrated by the detection of single molecules. (See K. Kneipp, Y. Wang, R. R. Dasari and M. S. Feld, Appl. Spectrosc., 49,780(1995); and S. Nie and S. R. Emory, Science, 275, 1102 (1997)).

Previous research has employed primarily the three most common methods of generating surface-enhanced Raman (SER) scattered radiation; i.e., using roughened silver or gold electrodes, using silver or gold-coated substrates, and using silver or gold colloids for detecting separated analytes. The lattermost method has gained the greatest amount of attention, since colloids can be prepared easily and inexpensively, and mixing of the colloids with the chromatographic column effluent, using flow injection, is reproducible. Care must be taken however to control aggregation of the colloids so that the amount of Raman signal enhancement is maintained. Also, a range of experimental variables, such as analyte concentration and pH, can strongly influence aggregation and, to some extent, limit applications; the choice of mobile phase is similarly limited by the need to maintain colloid integrity.

Recently, as described by Farquharson et al. in commonly owned U.S. Pat. No. 6,623,977 (filed under Application No. 09/704,818, and published as International Publication No. WO 01/33189 A2), the entire specification of which is hereby incorporated by reference thereto, sol-gels have been developed to trap silver or gold particles as an improved method of generating plasmons for SERS (see also S. Farquharson, P. Maksymiuk, K. Ong and S. D. Christesen, SPIE, 4577, 166(2002); F. Akbarian, B. S. Dunn and J. I. Zink, J. Chem. Phys., 99, 3892 (1995); T. Murphy, H. Schmidt and H. D. Kronfeldt. SPIE, 3105, 40 (1997); and Y. Lee, S. Dai and J. Young, J. Raman Spectrosc. 28, 635 (1997)). It is appreciated that, once the sol-gel has formed, the particle size and aggregation of the metal dopant are stabilized, albeit changes in pH may still result in variable Raman signal intensities, such as in the case of weak acids and bases, where the relative concentrations of the ionized and unionized forms may be influenced. Also, it has been shown that many of the common solvents, such as acetone, methanol, and water, can be used equally with these metal-doped sol-gels in generating SER spectra of analytes.

In accordance with other recent developments, moreover, sol-gels have been used as the stationary phase in columns for liquid- and gas-phase chromatography, affording advantages in both the preparation of columns and also in their performance. The sol-gel approach enables deactivation, coating, and immobilization to be combined as a single step, while the sol-gels have shown reduced tailing, improved separation, and broader application to solvents and analytes.

Microchip devices have also been employed for effecting chemical separations (see Jacobson, S. C., Hergen\ddot{r}oder, R., Koutny, L. B., & Ramsey, J. M. “High-Speed Separations on a Microchip,” Anal. Chem., 66, 1114-1118 (1994); Jacobson, S. C., Hergenröder, R., Koutny, L. B., Warmack, R. J., & Ramsey, J. M. “Effects of Injection Schemes and Column Geometry on the Performance of Microchip Electrophoreis Devices,” Anal. Chem., 66, 1107-1113 (1994); Jacobson, S. C. Hergenröder, R., Koutny, L. B. & Ramsey, J. M. “Open Channel Electrochromatography on a Microchip,” Anal. Chem., 66, 2369-2373 (1994); and Moore, Jr., A. W., Jacobson, S. C. & Ramsey, J. M. “Microchip Separations of Neutral Species via Micellar Electrokinetic Capillary Chromatography,” Anal. Chem., 67, 4184-4189 (1995)).

### STATEMENT REGARDING FEDERALLY SPONSORED RESEARCH OR DEVELOPMENT

The United States Government has rights in this invention pursuant to National Science Foundation Contract No. DMI-0060258.

### SUMMARY OF THE INVENTION

It is the broad object of the present invention to provide a novel method and apparatus for the separation and immediate qualitative and quantitative analysis of chemicals in solutions.

It has now been found that certain of the foregoing and related objects of the invention are attained by the provision of a method for substantially simultaneously separating and detecting at least one analyte chemical, wherein a solution, containing a plurality of chemicals, is transported through or along a stationary medium in sufficiently intimate contact for effecting separation, the medium being functional to separate at least one of the plurality of chemicals and also exhibiting surface-enhanced Raman (SER) scattering activity. The medium substantially concurrently is irradiated with excitation radiation to generate surface enhanced Raman scattered radiation, at least a portion of which is collected and analyzed to determine the presence of the analyte chemical in the solution. The stationary medium will usually comprise or define an elongate path for the solution, such as in a capillary column or a microchip channel, typically comprising a fixed surface deposit.

In certain preferred embodiments, the stationary medium will comprise at least one separation material and at least one surface-enhanced Raman active material. The SER active material may desirably be of particulate form, advantageously comprised of metal-doped sol-gels, metal-coated particles of polystyrene, silica, alumina or titania, particularly spheres of submicron size, or metal nanopaticles; the SER active material may also comprise a fixed surface deposit.

The SER active metal, utilized for affording surface-enhanced Raman scattering activity will normally be silver, gold, copper, or an alloy or mixture thereof. The metal will usually be of particulate form, preferably of submicron size, with the particles being either substantially isolated from one another or grouped for possible improvement of SER scattering. Such groupings can range in character from random to ordered, such as aggregates or patterned arrangements (e.g., linear or branched). The particles may comprise metals, metal colloids or metal-coated spheres of, for example, polystyrene, silica, alumina, zirconia or titania.

The separation material employed will be in the form of particles, matrices, gels, sol-gels, or integral elements, the latter taking the form of one or (more commonly) a plurality of porous plugs or membranes, or a fixed surface deposit. The separation material will generally be selected from the materials used in chromatography, i.e., gas, liquid, HPLC or thin layer chromatography. This group includes, but is not limited to, aero-gels, zero-gels, metal alkoxide-based sol-gels, silica gels, transition metal-stabilized silica, derivatized silica-based matrices, glass beads, long-chain alkanes, derivatized long-chain alkanes, polymers, derivatized polymers, functionalized membranes, alumina, size-exclusion resins, and ion-exchange resins. In certain instances the stationary medium will advantageously comprise at least one separation material combined with at least one surface-enhanced Raman active material. When both the SER active material and also the separation material are of particulate form, they will normally constitute a homogeneous mixture in which the separation material is present in a volumetric ratio to the surface-enhanced Raman-active material in the range of about 1×10⁶:1 to 1:1.

Other objects of the invention are attained by the provision of apparatus for effecting, substantially simultaneously, separation of at least one analyte chemical from a solution containing a plurality of dissolved chemicals, and detection of the separated chemical. The apparatus comprises elongate containment means for containing a stationary medium and having an entrance for introducing a sample solution thereinto, and a quantity of the stationary medium herein described. The containment means is sufficiently transparent to excitation radiation, at least at one location spaced longitudinally from the entrance, to permit transmission of excitation radiation effective for generating measurable amounts of surface-enhanced Raman scattered radiation, and it is sufficiently transparent to such SER radiation, at least at the same spaced location, to permit transmission of measurable amounts thereof. The stationary medium defines a flow path through the containment means, past at least the “at least one location,” and is of such character as to promote intimate contact with a sample solution transported along the defined flow path.

One or more suitable optical devices, capable of excitation and collection of Raman photons, monitors the “one” location of the transparent column for the detection of separated chemical species, thereby enabling an analysis to be accomplished; such an optical device may comprise a lens, a microscope objective, a fiber optic probe, etc. The rate at which the chemical and physical contact necessary for effecting separation of the species occurs can be promoted by driving the analyte solution through or along a bed, filled section or deposit of the stationary, chemical-separation and SER-active material, under applied positive or negative pressure.

The apparatus may comprise a packed or otherwise filled column of the stationary medium or, as an alternative, it may comprise a microchip card substrate. In such alternative embodiments the elongate containment means may take the form of a microchannel in the substrate or a capillary tube on the substrate, and the substrate may itself have a plurality of ports communicating with the channel and providing entrance-defining and exit-defining means; the stationary medium will advantageously comprise a lining deposited on a wall of the channel or tube, or a filled section contained within the channel or tube, defining the sample flow path. Additional features and functions may advantageously be incorporated into and implemented by the apparatus of the invention, as will be apparent from the description herein provided.

The instant invention uniquely combines two functions; i.e., (1) the ability to separate chemicals, and (2) the ability to promote SER scattered radiation from chemicals in solution, which combination in turn enables analyses to be performed in a highly effective and efficient manner. Although the sol-gels described advantageously combine both functions in a single material, it will be appreciated from the present description that two or more different materials can be mixed or combined to the same end.

### BRIEF DESCRIPTION OF THE DRAWINGS

FIG. 1 is a diagrammatic representation of a packed bed column used for separation and analysis of dissolved analytes, showing both the traditional, gravity-flow (with inherent capillary action) method of solution transport, with a single sampling point, and also a vacuum-assisted transport method with multiple sampling points;

FIG. 2 is a plot of Raman band relative intensity over a period of 100 minutes, constituting an elution profile of phenyl acetylene (PA) and p-amino-benzoic acid (PABA);

FIG. 3 presents a series of spectra, taken at five points along the length of a sol-gel packed column, representing a preferred embodiment of the invention, used for separation and measurement of concentrations of PA and PABA;

FIG. 4 is a diagrammatic representation of a microchip device incorporating a SER-active sol-gel chemical separation channel and enabled by the present invention; and

FIGS. 5 through 8 are SER spectra demonstrating separations effected in accordance with examples hereinafter set forth.

### DETAILED DESCRIPTION OF THE PREFERRED AND ILLUSTRATED EMBODIMENTS

The silver-doped SER-active sol-gels employed in the examples that follow were prepared in accordance with the method of Lee and Farquharson (SPIE 4206, 140 (2001). In essence, a silver amine complex, consisting of a 5:1 v/v solution of 1 N AgNO₃ and 28% NH₃OH, is mixed with an alkoxide, consisting of a 2:1 v/v solution of methanol and tetramethyl orthosilicate (TMOS) in a 1:8 v/v silver amine:alkoxide ratio.

As an example of a fabrication technique that can be used in the practice of the invention, a 0.15 mL aliquot of the foregoing mixture is transferred to a 2 mL glass vial, which is spun to coat its inside walls. After sol-gel formation, the incorporated silver ions are reduced with dilute sodium borohydride, followed by a water wash to remove residual reducing agent. The sol-gel coating is scraped from the walls of the vial, and is converted to a homogeneous powder by grinding with a mortar and pestle.

As depicted in FIG. 1, the ground sol-gel 10 is packed into a 5 mm segment of a 4 cm length of a 1.0 mm diameter melting point capillary tube 12, using a sterile cotton plug 14 to hold the powder in place, and the top is fit with a 1.0 mL disposable plastic pipette (not shown) to allow delivery of 10 μL samples to the rudimentary liquid chromatography column so prepared. A diaphragm pump (also not shown) is attached to the exit end of the column to enable vacuum-assisted transport of the test solution through the sol-gel bed.

The column is fixed vertically at the focal point of a microscope objective (20×0.4) attached to an XYZ positioning stage, to focus the beam into the sample and to collect radiation scattered back along the axis of incidence. A notch filter is provided to reflect the excitation laser beam to the microscope objective, and to pass the collected Raman-scattered radiation.

Two 3 m lengths of fiber optic were used to deliver the laser energy (200 micron diameter) and to collect the Raman radiation (365 micron diameter). A Nd:YAG laser provided 50 mW of 1064 nm excitation radiation at the sample, and a Fourier transform Raman spectrometer, equipped with an InGaAs detector, was used for spectra acquisition.

### EXAMPLE ONE

Insofar as the flow of analyte solution is concerned, the following experiment (depicted along the left side of FIG. 1) mimics traditional liquid chromatography. A solution of 8×10⁻³M p-aminobenzoic acid and 4×10⁻³M phenyl acetylene was prepared in methanol to demonstrate separation of polar and non-polar chemicals, respectively. A 10 μl quantity of the solution was added to the top of a separation and analysis column, constituted and assembled as hereinabove described. A 1 mL quantity of methanol was added as a carrier solvent, and allowed to elute under the forces of gravity and capillary action only. Using an optical probe coupled to a Raman spectrometer, which measured the surface-enhanced Raman spectra at the bottom of the column as a function of time, it was confirmed that the methanol solvent caries the non-polar PA through the column ahead of the polar PABA.

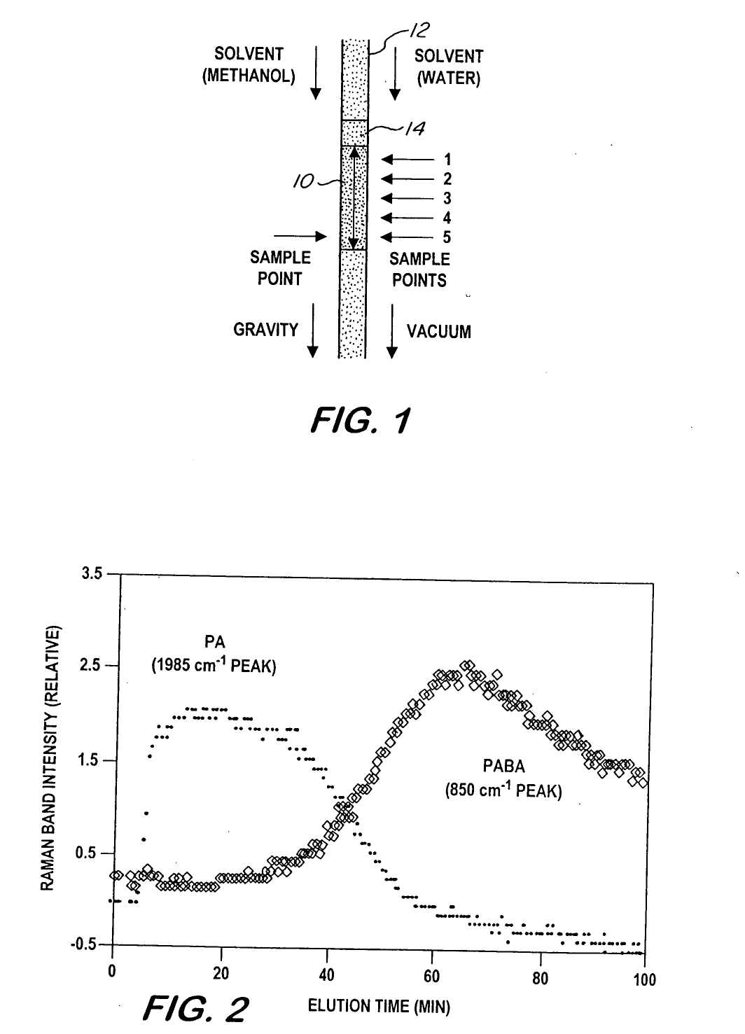

More specifically the microscope objective was positioned 0.5 mm from the bottom edge of the 5 mm length of packed sol-gel, and scans were made and averaged every 30 seconds to produce spectra. Unique bands for PA and PABA, at 1985 cm⁻¹ and 850 cm⁻¹, respectively, were used to plot relative concentration as a function of time. FIG. 2 shows the elution profiles generated for both analytes during a 100 minute test period, which verify that chemical separation does occur. These data also show however that, in the absence of any external driving force, a significant period of time is required.

### EXAMPLE TWO

This Example demonstrates that techniques can be applied for driving the solution through the column to substantially reduce analysis time. Thus, a second experiment (depicted along the right side of FIG. 1) employs an identical sample but uses a 50/50 v/v mixture of methanol and water as the carrier solvent, rather than methanol alone. In addition, a vacuum of 50 cm of Hg was applied for 30 seconds to draw the sample through the column. Due to the addition of water in the solvent, the separation is reversed because, in the present case, the alkoxide, TMOS, used to prepare the sol-gel is hydrophilic (i.e., water carries the polar PABA through the column first), demonstrating flexibility of the concept.

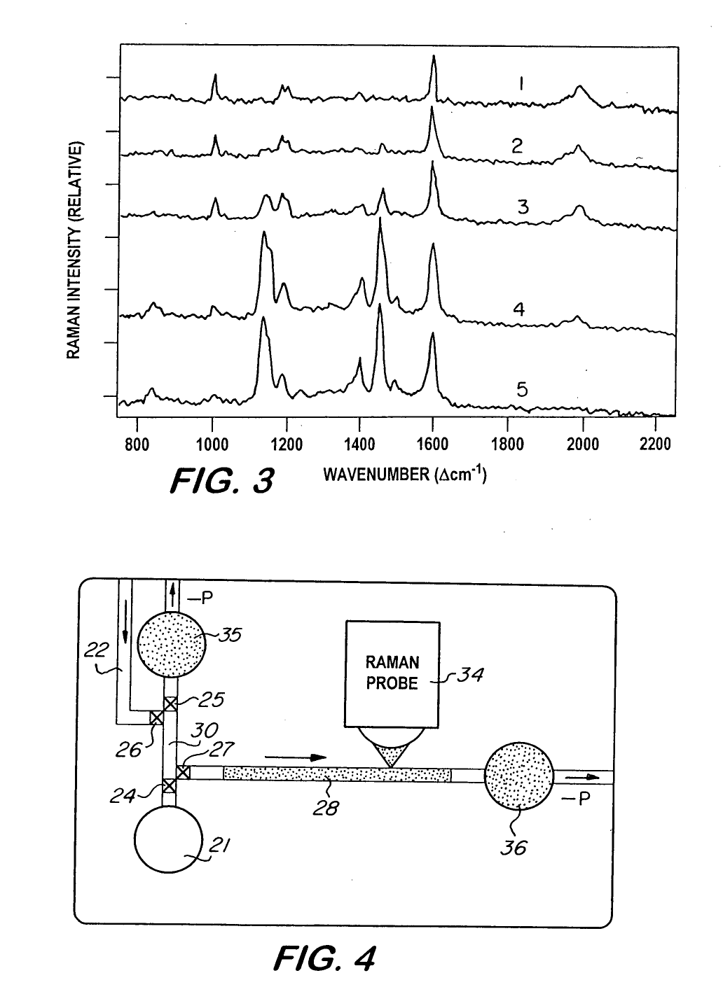

Since the entire length of the column is SER-active, moreover, the extent of separation could be measured by moving the microscope objective to five different positions along its length, enabling the collection of spectra at each level. More specifically, spectra, plotted in FIG. 3, were collected at five discrete points spaced 1 mm apart, the first being located at a level 0.5 mm from the top edge of the sol-gel bed, with each spectrum consisting of scans averaged for 30 seconds. Spectra (1) and (5), obtained at the top and bottom of the column, indicate pure PA and PABA, respectively; the intermediate spectra represent mixtures of the two analytes.

Because there was no need to wait for the analytes to elute past a single measurement point at the end of the column (i.e., the separated chemicals can be measured wherever they occur along the column, since it is SER-active along its entire length), each analyte could be identified quickly; complete analysis was performed in three minutes, as compared to at least 80 minutes using the traditional method. The time savings realized provides many significant benefits, particularly for trace chemical analyses of multi-component systems.

The series of spectra presented in FIG. 3 also demonstrates the power of Raman spectroscopy, in that each chemical can be easily identified, either isolated or as a mixture. Although previous knowledge of, or expectation as to, the sample composition simplifies the task, spectral matching and deconvolution software programs, or like techniques, can be used to handle unknown components.

### EXAMPLE THREE

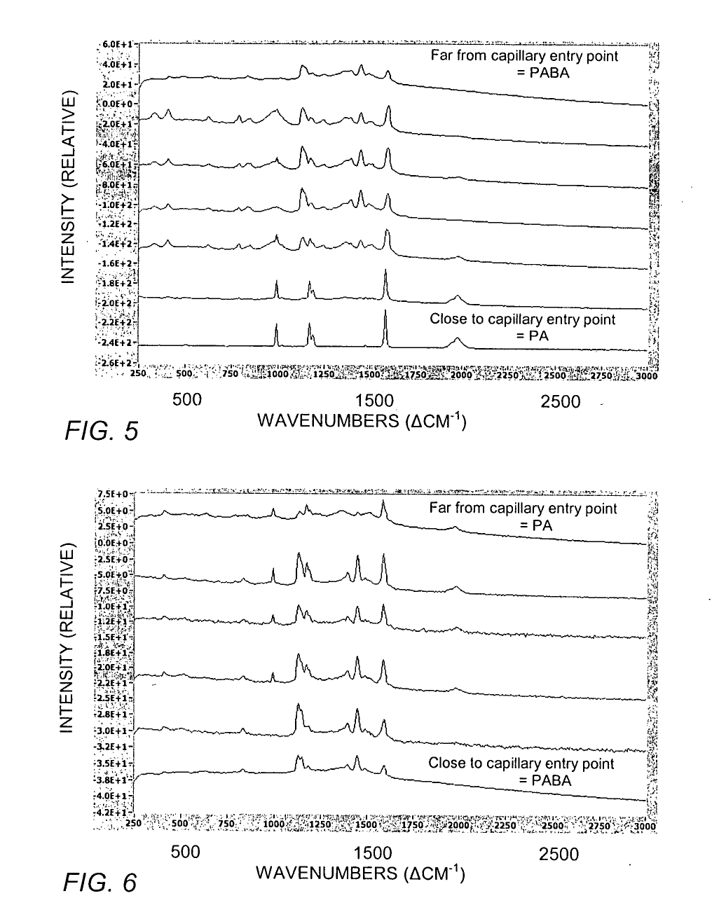

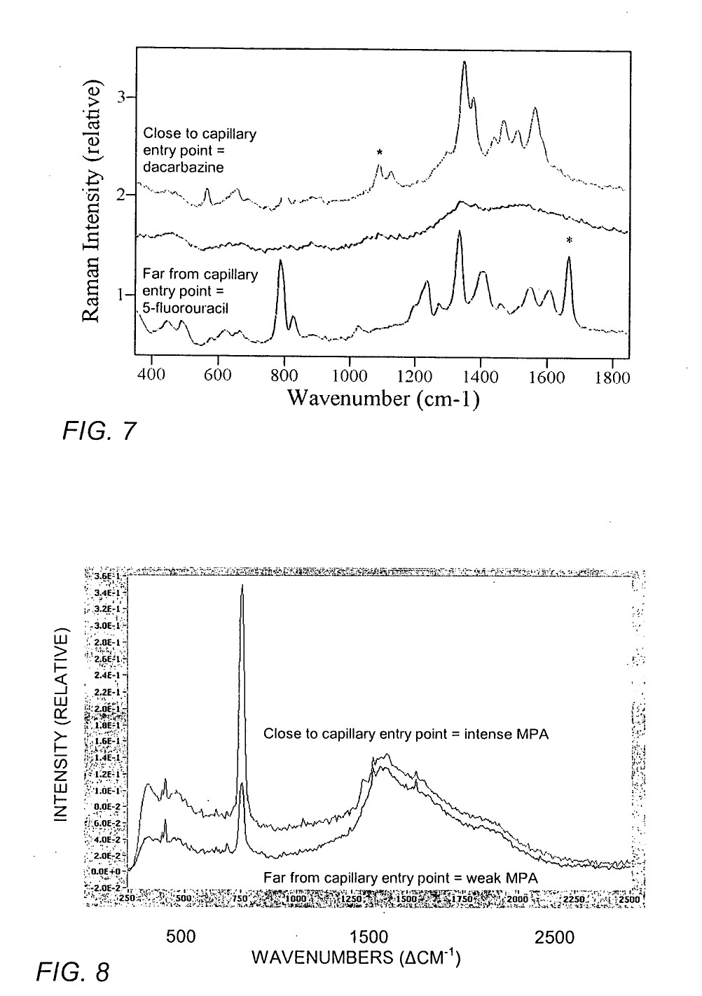

As a variant of the system used in Examples One and Two (which employ a silver-doped TMOS-based sol-gel, scraped from the wall of the vial in which it is prepared and packed into a 1 mm diameter glass capillary), this Example employs sol-gels that have been gelled and reduced in the capillary. FIG. 5 shows spectra for two cases in which the separation of a mixture of PABA and PA was effected, the mixture having been prepared from equal volumes of a solution of 1 mg PABA in 1 mL water, and 0.1 mL PA liquid mixed in 0.9 mL methanol.

In one case, the sol-gel employed was prepared from a methyltrimethoxysilane (MTMS) alkoxide as a non-polar stationary phase; in the other case the sol-gel was prepared from a 5/1 v/v MTMS/TMOS alkoxide mixture as a somewhat polar stationary phase. In both instances approximately 0.1 mL of the PABA/PA mixture was first placed into the front end of the capillary, approximately 1 mL of water then was drawn, as the polar mobile phase, into the capillary effecting separation, and finally the capillary was mounted in front of an objective lens and spectra were recorded at discrete positions along its length.

The bottom spectrum in FIG. 5 was collected closest to the sample entry point, and the top spectrum was collected farthest from the same point. Polar PABA (top spectrum) readily flows past the non-polar MTMS sol-gel, while the non-polar PA (bottom spectrum) lags behind as it interacts strongly with the non-polar MTMS.

FIG. 6 shows exactly the reverse separation. The non-polar PA (top spectrum) readily flows past the somewhat polar MTMS/TMOS sol-gel, while the polar PABA (bottom spectrum) lags behind as it interacts strongly with the somewhat polar MTMS.

### EXAMPLE FOUR

This Example demonstrates that traditional chromatography materials can be employed in the column to aid separation. Specifically, a porous plug of silica gel was placed in a capillary above (i.e., upstream of) a silver-doped MTMS-based sol-gel. Traditional silica gels separate chemicals based upon the retarding effect of hydrogen interactions, to slow elution of a given chemical; i.e., the greater the number and the polarity of functional groups in the analyte molecule the greater the number of interactions, and hence the greater the level of retardation that will occur.

In this Example, a 50/50 v/v mixture of 5-flourouracil and dacarbazine, at 0.5 mg/mL each in water, was drawn by syringe into the silica gel. Then ethanol, functioning as the carrier solvent, was drawn by syringe into the column. FIG. 7 shows the SER spectrum of dacarbazine close to the entry point (top spectrum), and the SER spectrum of 5-flourouracil far from the entry point (bottom spectrum). As will be appreciated, the less polar 5-flourouracil is carried more readily by ethanol through the somewhat polar silica gel. The absence of evidence of either chemical from the SER spectrum taken at an intermediate point demonstrates that separation is complete.

### EXAMPLE FIVE

This Example demonstrates an alternative method for adding SER-active metals to separation materials, in accordance with the present invention. More particularly, an MTMS-based sol-gel was used to fill a glass capillary and, following gelation, an approximately 10⁻³M silver colloid solution, prepared according to literature methods (e.g., P. C. Lee and D. Meisel, J. Phys. Chem., 86, 3391, 1982), was drawn by syringe through the sol-gel. After waiting for about five minutes, a 1 mg/mL aqueous solution of methyl phosphonic acid (MPA) was drawn into the SER-active capillary thus produced. SER spectra, observed at multiple points, show that the polar MPA does not readily pass through the non-polar MTMS-based sol-gel, and that SER spectra are most intense near the entry point.

### EXAMPLE SIX

A microchip chemical analyzer, diagrammatically illustrated in FIG. 4, constitutes a form of apparatus enabled by the present invention. The analyzer comprises a card, generally designated by the numeral 20, which contains a sample input port 21, a solvent entry channel 22, valves 24, 25, 26 and 27, and a SER-active sol-gel microchannel 28. In this instance the sol-gel takes the form of a porous lining deposited on the wall of the channel 28 (albeit a packed channel is also feasible), and an applied vacuum driving force promotes rapid passage through the channel 28 coupled with the physical and chemical contact required for effective separation.

In use, a sample (e.g., a drop of blood) is applied to a porous cover, such as a membrane or sponge overlying the sample entry port 21 (or the port may be of septum-like form), typically using an eye dropper, a pipette, or a syringe. The sample is then urged, such as by vacuum applied at the waste chamber 35 (or alternatively, by positive pressure such as may be applied by a pipette or syringe, always using of course appropriate connections), into a load channel section 30, for which purpose the valves 24 and 25 would be opened and the valves 26 and 27 would be closed. Then, with valves 24 and 25 closed to isolate the sample entry port 21 and the waste chamber 35, and the valves 26 and 27 opened, solvent is drawn (or alternatively, pushed) through the channel 22 to drive the loaded sample through the passage of the channel 28 to waste chamber 36, again with vacuum (or pressure) applied thereat. Chemical components of the sample interact with the sol-gel deposit and are thereby separated, allowing identification and quantitation of the target analyte(s) by SER spectroscopy using a Raman optical probe such as a suitably mounted objective 34 with the appropriate interface optics. The microchip card 20 would typically fit onto a platform that aligns interconnects for the sample/solvent delivery and flow-control system, and that dynamically positions the Raman probe objective to enable spectral analyses to be effected along the length of the SER-active portion of the channel 28, as described.

It will be appreciated that, in those instances in which a sol-gel is used as a separation/analysis medium in the practice of the present invention, virtually any sol-gel, in powdered, particulate or other finely divided form, or in-the form of a porous, passage-defining deposit, can be employed. Selectivity may be afforded by the inherent electro-potential of the metal dopant (electronegative or electropositive) and/or by the hydrophobic or hydrophilic nature of such a sol-gel medium, etc. Thus, while certain of the Examples set forth above employ a silver-doped sol-gel, doping with gold is regarded to be equally important; copper, and less desirably nickel, palladium, and platinum, and alloys and mixtures thereof, can of course be utilized as well.

The literature describes a number of method by which SERS active materials, suitable for use in the practice of the present invention, can be produced. For example, a paper entitled “Surface-Enhanced Raman Spectrometry for Trace Organic Analysis” (Tuan Vo-Dinh, M. Y. K. Hiromoto, G. M. Begun, and R. L. Moody, Anal. Chem. 56, 1667-1670, 1984) describes a method for preparing SERS-active substrates using submicron size silver-coated spheres deposited on filter paper substrates; a paper entitled “Titanium Dioxide Based Substrate for Optical Monitors in Surface-Enhanced Raman Scattering Analysis” (Job M. Bello, David L. Stokes, and Tuan Vo-Dinh, Anal. Chem., 61, 1779-1783, 1989) describes an optical monitor consisting of a glass plate coated with TiO₂ and covered with a silver layer (which coating could be removed and employed as particulate material in the practice of the present invention); in a paper entitled “Surface-Enhanced Raman Analysis of p-Nitroanaline on Vacuum Evaporation and Chemically Deposited Silver-Coated Alumina Substrates” (Ying-Sing Li, Tuan Vo-Dinh, David L. Stokes, and Yu Wang, Applied Spectroscopy 46, 1354-1357, 1992) vacuum thermally evaporated and chemically prepared silver-coated alumina substrates are described; and in a paper entitled “On-Line Spectroscopic Characterization of Sodium Cyanide with Nanostructured Gold Surface-Enhanced Raman Spectroscopy Substrates (Peter M. Tessier, Steven D. Christesen, Kate K. Ong, Eva M. Clemente, Abraham M. Lenhoff, Eric W. Kaler, and Orlin D. Velev, Applied Spectroscopy, 46, 1524-1530, 2002), a technique is described for producing SERS substrates by the deposition of metallic nanoparticles on a substrate using gold nanoparticles and polystyrene microspheres. Needless to say, these and other suitable techniques can be employed to produce substrates and particulate materials effective for use in practicing the invention, utilizing any of the several SER-active metals disclosed herein.

As indicated above, the SER-active particles (e.g., of silver or gold) can be prepared by any suitable means, mixed with a suitable stationary medium for effecting chemical separation, and introduced into a suitable enclosure, such as a glass tube or capillary. Alternatively, the SER-active material may be coated upon the container walls, with a particulate adsorbent material filling the space therewithin, or the separation material may take any other suitable form, as indicated hereinabove.

The nature and structure of the containment vessel can vary widely, and is not limited to columns; for example (and as has been described), the analysis apparatus may comprise glass or plastic microchannels incorporated into microchip analyzers. Albeit the sample path will usually be rectilinear, it will be appreciated that the elongate path referred to herein may be curvilinear and of relatively complex, compound configuration as well. A fluidic device used to add solvent and push and/or pull the sample through the SER-active medium, for effecting sample introduction and separation, can also take many different forms, it being appreciated that the functional features of the device may be important from the stand-point of assuring the intimacy of contact necessary for efficient separation of the analyte chemical(s). Similarly, and as mentioned above, the optical device employed to irradiate the sample and collect SER radiation can take many different forms; as one example, however, the device may desirably comprise six collection optical fibers surrounding one excitation energy delivery fiber.

Numerous applications can benefit from the method and apparatus of the invention, including, for example, the detection of chemical contaminants (e.g. CN⁻, CrO₄⁻) in groundwater, the determination of drug presence and efficacy (by analysis for a parent constituent and/or its metabolites in a biological fluid), and the detection of chemical agent hydrolysis products in poisoned water. Other applications will readily occur to those skilled in the art.

It should be understood that the term “solution” is used in a broad sense in the present description and claims. It is intended to encompass colloidal suspensions (of dispersed solid, semisolid, and liquid particles) in a fluid (gas or liquid) continuous phase, as well as true solutions (i.e., at the molecular or ionic level) of one or more dissolved substances in a simple or mixed fluid solvent.

Thus, it can be seen that the present invention provides a novel method and apparatus for the separation, and immediate qualitative and quantitative analysis, of chemicals in solution.

Having thus described the invention, what is claimed is:

1. A method for substantially simultaneously separating and detecting at least one analyte chemical in a solution, comprising:
transporting a sample solution containing a plurality of chemicals, including at least one analyte chemical, through or along a stationary medium in sufficiently intimate contact with the medium for effecting separation of said at least one analyte chemical, said stationary medium being functional to separate at least one of said plurality of chemicals and also exhibiting surface-enhanced Raman scattering activity;
substantially concurrently irradiating said medium with excitation radiation to generate surface-enhanced Raman scattered radiation;
collecting at least a portion of said surface-enhanced Raman scattered radiation; and
analyzing said collected radiation to determine the presence of said analyte chemical in said sample solution.

2. The method of claim 1 wherein said stationary medium comprises or defines an elongate path for said sample solution.

3. The method of claim 1 wherein said stationary medium incorporates a surface-enhanced Raman active metal selected from the group consisting of silver, gold, copper, and alloys and mixtures thereof.

4. The method of claim 3 wherein said surface-enhanced Raman active metal is of particulate form.

5. The method of claim 4 wherein the particles of said surface-enhanced Raman active metal are of submicron size.

6. The method of claim 4 wherein said surface-enhanced Raman active metal particles comprise metal colloids or metal-coated particles of polystyrene, silica, alumina, zirconia or titania.

7. The method of claim 6 wherein said metal-coated particles are spheres of submicron size.

8. The method of claim 4 wherein said surface-enhanced Raman active metal particles are substantially isolated from one another.

9. The method of claim 3 wherein said surface-enhanced Raman active metal is in the form of particulate groupings, or elements of substantially regular character, to optimize surface-enhanced Raman scattering.

10. The method of claim 9 wherein said particulate groupings are random.

11. The method of claim 9 wherein said particulate groupings are ordered.

12. The method of claim 1 wherein said at least one surface-enhanced Raman active material comprises a fixed surface deposit.

13. The method of claim 1 wherein said stationary medium comprises at least one separation material and at least one surface-enhanced Raman active material.

14. The method of claim 13 wherein said at least one surface-enhanced Raman active material is of particulate form.

15. The method of Claim 13 wherein said at least one separation material is in the form of particles, matrices, gels, sol-gels, or integral elements.

16. The method of claim 13 wherein said at least one separation material comprises an integral element in the form of a porous plug, a membrane, or a fixed surface deposit.

17. The method of claim 14 wherein said at least one separation material is of particulate form, wherein said particulate materials constitute a homogeneous mixture, and wherein said at least one separation material is present in said stationary medium in a volumetric ratio to said at least one surface-enhanced Raman active material in the range of about 1×10⁶:1 to 1:1.

18. The method of claim 1 wherein said stationary medium comprises at least one separation material selected from the group consisting of aero-gels, zero-gels, metal alkoxide-based sol-gels, silica gels, transition metal-stabilized silica, derivatized silica-based matrices, glass beads, long-chain alkanes, derivatized long-chain alkanes, polyomers, derivatized polymers, functionalized membranes, alumina, size-exclusion resins, and ion-exchange resins.

19. The method of claim 1 wherein said stationary medium comprises a liquid chromatography separation material.

20. Apparatus for effecting, substantially simultaneously, separation of at least one analyte chemical from a sample solution containing a plurality of dissolved chemicals, and detection of the at least one analyte chemical, said apparatus comprising:
elongate containment means for containing a stationary medium and being sufficiently transparent to excitation radiation, at least at one location along its length, to permit transmission of excitation radiation effective for generating measurable amounts of surface-enhanced Raman scattered radiation, and being sufficiently transparent to surface-enhanced Raman scattered radiation, at least at said one location, to permit transmission of measurable amounts of such surface-enhanced Raman radiation;
a quantity of stationary medium, functional to separate at least one of the chemicals contained in the sample solution and also exhibiting surface-enhanced Raman scattering activity, contained in said containment means and defining a flow path through said containment means past said at least one location, said medium being of such character as to promote intimate contact with a sample solution transported along said flow path; and
means for defining an entrance for a sample solution to said flow path, said at least-one location being spaced from said entrance along the length of said containment means.

21. The apparatus of claim 20 comprising a filled column of said stationary medium.

22. The apparatus of claim 20 wherein said stationary medium incorporates a surface-enhanced Raman active metal selected from the group consisting of silver, gold, copper, and alloys and mixtures thereof.

23. The apparatus of claim 20 additionally including a microchip card substrate bearing said elongate containment means.

24. The apparatus of claim 23 wherein said elongate containment means comprises a microchannel in said substrate, said substrate having a plurality of ports communicating with said microchannel and providing said entrance-defining means and an exit-defining means.

25. The apparatus of claim 24 wherein said stationary medium comprises a lining deposited on a wall of said elongate containment means and defining said sample flow path.

26. The apparatus of claim 22 wherein said surface-enhanced Raman active metal is of particulate form.

27. The apparatus of claim 26 wherein the particles of said surface-enhanced Raman active metal are of submicron size.

28. The apparatus of claim 26 wherein said surface-enhanced Raman active metal particles comprise metal colloids or metal-coated particles of polystyrene, silica, alumina, zirconia or titania.

29. The apparatus of claim 28 wherein said metal-coated particles are spheres of submicron size.

30. The apparatus of claim 28 wherein said surface-enhanced Raman active metal particles are substantially isolated from one another.

31. The apparatus of claim 28 wherein said surface-enhanced Raman active metal is in the form of particulate groupings or elements of substantially regular character, to optimize surface-enhanced Raman scattering.

32. The apparatus of claim 23 wherein said at least one surface-enhanced Raman active material comprises a fixed surface deposit.

33. The apparatus of claim 23 wherein said stationary medium comprises at least one separation material and at least one surface-enhanced Raman active material.

34. The apparatus of claim 33 wherein said at least one surface-enhanced Raman active material is of particulate form.

35. The apparatus of claim 33 wherein said at least one separation material is in the form of particles, matrices, gels, sol-gels, or integral elements.

36. The apparatus of claim 33 wherein said at least one separation material companies an integral element in the form of a porous plug, a membrane, or a fixed surface deposit.

37. The apparatus of claim 34 wherein said at least one separation material is of particulate form, wherein said particulate materials constitute a homogeneous mixture, and wherein said at least one separation material is present in said stationary medium in a volumetric ratio to said at least one surface-enhanced Raman active material in the range of about 1×10⁶:1 to 1:1.

38. The apparatus of claim 23 wherein said stationary medium comprises at least one separation material selected from the group consisting of aero-gels, zero-gels, metal alkoxide-based sol-gels, silica gels, transition metal-stabilized silica, derivatized silica-based matrices, glass beads, long-chain alkanes, derivatized long-chain alkanes, polyomers, derivatized polymers, functionalized membranes, alumina, size-exclusion resins, and ion-exchange resins.

39. The apparatus of claim 23 wherein said stationary medium comprises a liquid chromatography separation material.
